(19) United States
(12) Patent Application Publication
(10) Pub. No.: US 2011/0167033 A1
(43) Pub. Date: Jul. 7, 2011

(54) ALLOCATING RESOURCES IN A DATA WAREHOUSE

(76) Inventors: David STRELITZ, Encinitas, CA (US); Todd BASHOR, San Diego, CA (US); Lionel FRADIN, Asheville, NC (US)

(21) Appl. No.: 12/652,424

(22) Filed: Jan. 5, 2010

(51) Int. Cl. G06F 17/30

(52) U.S. Cl. 707/602; 707/E17.107

(57) ABSTRACT

Systems, methods and computer-readable storage media are provided for allocating resources in a data warehouse. A table of resources may be retrieved from the data warehouse, the table including a plurality of records, each record having data that describes a resource to be allocated. A first resource described in a first record of the table of resources may be reserved pursuant to a first rule of a first stage. The first resource may then be allocated into one or more records of a working allocation table pursuant to the first rule.

### BACKGROUND

An organization may store data in a number of heterogeneous data sources, such as operational databases, websites, spreadsheets and user files. This data may be aggregated into a data warehouse. Data typically is stored in a data warehouse in a consistent and normalized manner in order to allow efficient analysis and reporting. Tools may be provided to Extract, Transform and Load (“ETL”) data from heterogeneous data sources to a data warehouse.

Data aggregated into a data warehouse from heterogeneous data sources may have various may be characterized by over-granularity, lack of granularity (data is categorized into very large groups), and missing or invalid data that may be helpful for useful analysis and reporting.

Additionally, data aggregated from heterogeneous sources may represent the same or related information in different ways. For example, a user may wish to compare actual expenditures against planned expenditures, by organization. If these two types of information are derived from different data sources, the user may find that planned expenditures are categorized by organization, but actual expenditures are categorized by project and are not tied to a particular organization.

### BRIEF DESCRIPTION OF THE DRAWINGS

FIG. 1 depicts an example system including multiple data sources, a data warehouse and an allocation application that may be used to allocate resources, according to an embodiment of the invention.

FIG. 2 depicts an example method of allocating resources of a data warehouse, according to an embodiment of the invention.

FIG. 3 depicts a Graphical User Interface (“GUI”) for configuring scenarios, according to an embodiment of the invention.

FIG. 4 depicts a GUI for configuring stages, according to an embodiment of the invention.

FIG. 5 depicts a GUI for configuring rules, according to an embodiment of the invention.

FIG. 6 depicts another GUI for configuring source and target criteria for a particular rule, according to an embodiment of the invention.

### DETAILED DESCRIPTION

Systems, methods and computer-readable storage media are provided for allocating and/or reallocating resources in a data warehouse to improve analysis and reporting capabilities. An original table of resources may be retrieved from the data warehouse. Each record of the original table of resources may have data that describes a resource. The records of the original table of resources may be reserved, allocated and reallocated to records of various destination tables based on one or more rules that are contained in one or more stages of a scenario.

Each rule may include source criteria, which determine which records of resources are to be reserved. Each rule also may include target criteria, which may determine the destination of the reserved records of resources.

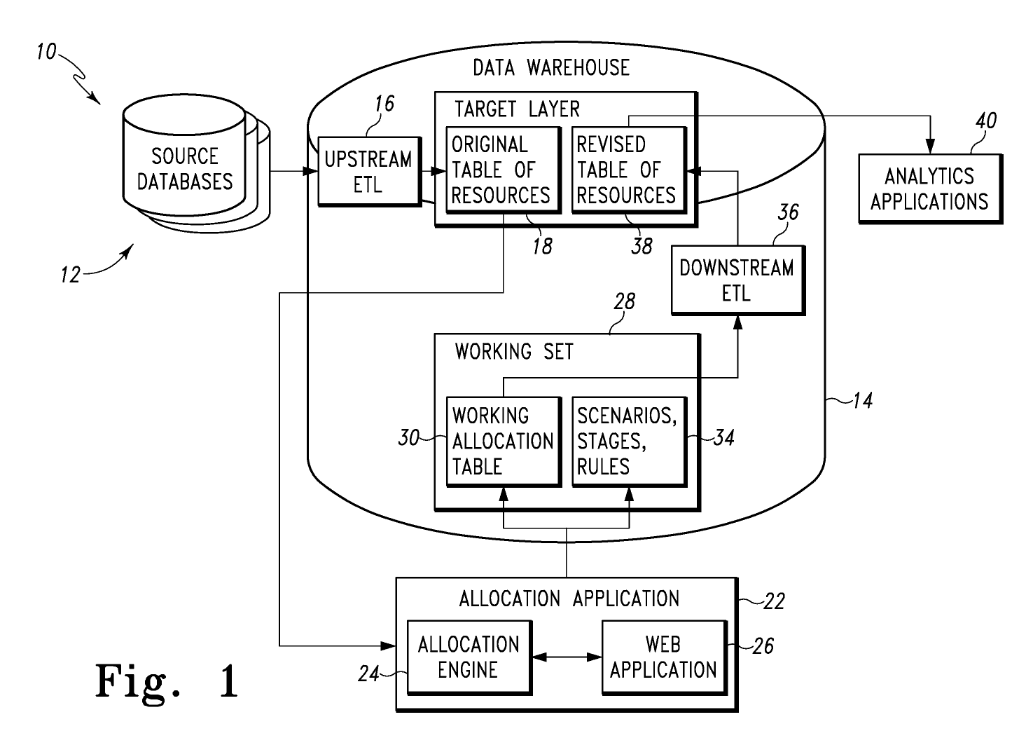

An example system 10 is shown in FIG. 1 that includes one or more data sources 12 and a data warehouse 14 into which data from the one or more data sources 12 may be aggregated. An upstream ETL component 16 may extract, transform and load data from one or more data sources 12 to data warehouse 14 in a normalized form.

The one or more data sources 12 may include any number of homogeneous and heterogeneous data sources, such as operational databases, spreadsheets, text files, emails, web pages, and other computer files. Various components, such the one or more data sources 12, data warehouse 14 and other components described herein, may be in communication over one or more wired or wireless computer networks (e.g., LANs, WANs such as the Internet).

An original table of resources 18 may be retrieved from the data warehouse 14. The original table of resources 18 may include one or more records, each having data that describes a resource to be allocated. The data in each record may be characterized by one or more dimensions. For example, a record may describe a resource that is allocated to a particular organization. Original table of resources 18 may be retrieved from data warehouse 14 by an allocation application 22.

Allocation application 22 may include an allocation engine 24 and an allocation application interface 26 (depicted in FIG. 1 as a “web application”). Allocation application 22 may be a computer program, executing on one or more computer processors. Allocation application 22 may be configured to cause allocation engine 24 (which also may be a computer program) to perform a series of steps on data retrieved from data warehouse 14, such as original table of resources 18, in order to allocate resources to one or more destination tables.

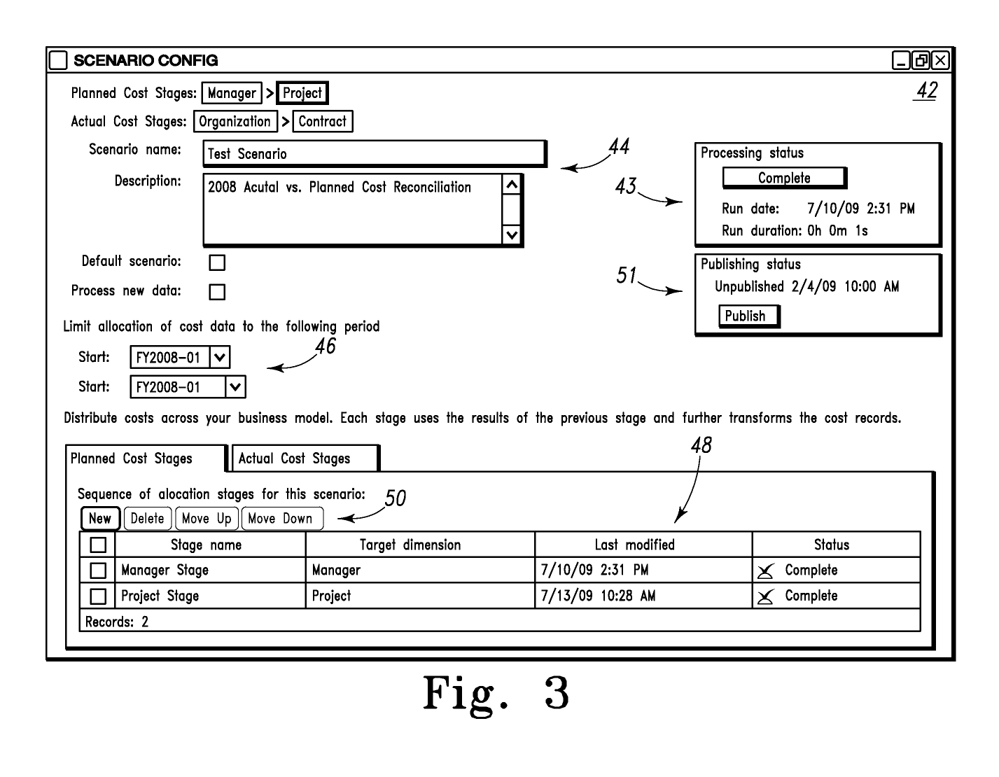

Allocation application interface 26 may be a user interface usable to control allocation engine 24 and allocation application 22 as a whole. Allocation application interface 26 may include a traditional GUI, a command line interface or a web-based interface. Examples of GUIs that may be usable to configure and control allocation application 22 are shown in FIGS. 3-6.

Allocation engine 24 may execute separately and/or asynchronously from the allocation application interface 26. Allocation engine 24 may be configured to respond to various events generated at the allocation application interface 26. These events will be discussed further below.

Allocation engine 24 may perform operations on data within a working set 28. The working set 28 may include a working allocation table 30 and one or more scenarios, stages and rules 34. Allocation engine 24 may be configured to allocate data from original table of resources 18 into working allocation table 30, as well as reallocate resources from working allocation table 30 back into new records of working allocation table 30, based on scenarios, stages and rules 34. Allocation engine 24 ultimately may provide final allocated resources to a downstream ETL process 36 that may write the data into a revised table of resources 38 of the data warehouse 14. Revised table of resources 38 may be available to various analytics applications 40.

As noted above, a scenario may include one or more stages, and a stage may include one or more rules with source and target criteria. Users may design scenarios in order to revise data in a data warehouse to be more useful for analytics and reporting. Each scenario may be created with a particular purpose, which may be creating revised fact data that is suitable for that particular user's needs. For example, a user may wish to compare actual expenditures against planned expenditures, by organization. If these two types of information are derived from different sources, the user may find that planned expenditures are categorized by organization and actual expenditures are categorized by project. The user may create a scenario that allows for derivation of the organization from the project. The results may be stored back in the data warehouse (e.g., in revised table of resources 38) so that it is available to various applications, such as analytics applications 40 of FIG. 1.

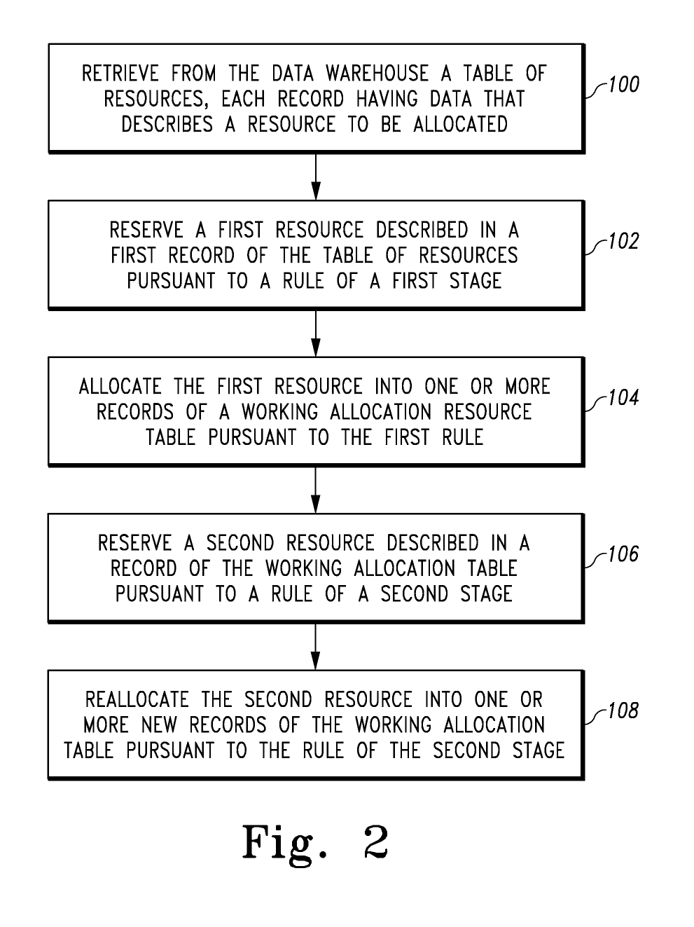

FIG. 2 depicts an example method of allocating resources in a data warehouse that may be performed by an allocation engine (e.g., 24 in FIG. 1). Although these steps are shown in a particular sequence, it should be understood that these steps may be performed in other sequences, with steps being rearranged and/or performed simultaneously in some cases. In step 100, an original table of resources is retrieved from the data warehouse. The table may include a one or more records, each record having data that describes a resource to be allocated.

In step 102, a first resource described in a first record of the table of resources is reserved pursuant to a first rule of a first stage. Although only a single resource in a single record of a table of resources is shown in FIG. 2 being reserved by the first rule, a second resource described in a second record of the table of resources also may be reserved pursuant to the first rule. The records that are reserved may be determined based on source criteria of the rule, which may return multiple records of resources. For example, if a rule calls for resources having a DEPT_ID equal to 10, then all records of resources that have a DEPT_ID=10 will be reserved. The example application described below includes such an occurrence.

Step 102 may include creating or adding data to an allocation reservation table. An allocation reservation table may track records of resources that been reserved, preventing later attempts to reserve the same resources. For example, an identifier associated with the first record reserved in step 102 may be stored in an allocation reservation table to indicate that the record with data describing the first resource has been reserved. An example of an allocation reservation table is discussed in an example application below.

In step 104, the first resource reserved in the table of resources in step 102 is allocated into one or more records of a working allocation table pursuant to target criteria of a rule of the first stage. The number of records into which the first resource is allocated, as well as the amount of the resource that is allocated to each record, depends on the target criteria of the rule.

Once all rules of a stage are processed by the allocation engine, subsequent stages of rules may be processed. In some embodiments, once all rules of a first stage are processed and the resources described in the original table of resources (e.g., 18 in FIG. 1) are allocated into a working allocation table (e.g., 30 in FIG. 1), rules in subsequent stages may be processed using the data from the working allocation table, rather than the original table of resources retrieved from the data warehouse. In some embodiments, the resource may be reallocated into one or more new records of the working allocation table. Examples of this are seen in the example application discussed below.

Referring back to FIG. 2, in step 106, a second resource is reserved pursuant to a rule of a second stage. Because the method is past the first stage, the records that are reserved may be records of a working allocation table. Rules of each stage after the first stage may reserve records from the working allocation table and reallocate the reserved resources back into new records of the working allocation table. For example, in step 108, the second resource described in the record of the working allocation table reserved in step 106 is reallocated into one or more new records of the working allocation table pursuant to the rule of the second stage.

Eventually, data allocated from the table of resources into a working allocation table, and data reallocated from the working resources table back into new records of the working resources table, may be written back into data warehouse for analytics and reporting. For example, data from records of the working allocation table that were created in a final stage of a series of stages in a scenario may be written back to a data warehouse by the downstream ETL component 36 of FIG. 1. In some examples, the stage during which a record of the working allocation table was added may be stored in the record, so that the records added during the final stage are easily discernable.

### Example Application

To best understand methods described herein, it is helpful to discuss an example. Assume that a scenario has been created with the following stages and rules:

Stage 1: Department
Rule 1:
   Source Criteria: dept_id=1 or dept_id=3
   Target Criteria: dept_id→2 percentage: 100% formula: amount *2.50
Rule 2:
   Source Criteria: dept_id is null
   Target Criteria: dept_id→5
Rule 3:
   Copy remaining (catch-all rule)

Stage 2: Location
Rule 1:
   Source Criteria: location_id is null
   Target Criteria: location_id→88 (50%); 99 (50%)
Rule 2:
   Copy remaining (catch-all rule)

Now, assume that an original table of resources has been retrieved from data warehouse that contains the following records:

| COST_ID | AMOUNT | DEPT_ID | ASSET_ID | LOC_ID |
|---|---|---|---|---|
| 1 | 10 | 1 | 5 | |
| 2 | 15 | 3 | 5 | |
| 3 | 4 | 2 | | 8 |
| 4 | 2 | | 4 | 8 |
| 5 | 75 | 5 | 4 | 8 |

Rule 1 of the first stage of the example scenario searches for any resource (i.e. a record) where the DEPT_ID is equal to 1 or 3. That captures records 1 and 2 of the table of resources, above. To reserve these records and prevent them from be reused, the following information may be added to an allocation reservation table:

| ID | COST_ID | STAGE ID | RULE_ID |
|---|---|---|---|
| 1 | 1 | 1 | 1 |
| 2 | 2 | 1 | 1 |

The following records may be added to an working allocation table in accordance with the Target Criteria of Rule 1 of Stage 1:

| COST_ID | AMOUNT | DEPT_ID | ASSET_ID | LOC_ID | STAGE_ID | RULE_ID |
|---|---|---|---|---|---|---|
| 1 | 25 | 2 | 5 | | 1 | 1 |
| 2 | 37.5 | 2 | 5 | | 1 | 1 |

As shown in the working allocation table, above, 100% of each resource reserved from the table of resources that has a DEPT_ID of either 1 or 3 is multiplied by 2.5 (10×2.5=25; 15×2.5=37.5) and allocated to the department having DEPT_ID=2.

The next rule, Rule 2 of Stage 1, seeks all records of resources where the DEPT_ID is null, and allocates them to the department having the DEPT_ID equal to 5. This will reserve record 4 of the table of resources. Accordingly, after Rule 2 of stage 1 is processed, the allocation reservation table will look like this:

| ID | COST_ID | STAGE ID | RULE_ID |
|---|---|---|---|
| 1 | 1 | 1 | 1 |
| 2 | 2 | 1 | 1 |
| 3 | 4 | 1 | 2 |

A third record would be added to the working allocation table as shown below:

| COST_ID | AMOUNT | DEPT_ID | ASSET_ID | LOC_ID | STAGE_ID | RULE_ID |
|---|---|---|---|---|---|---|
| 1 | 25 | 2 | 5 | | 1 | 1 |
| 2 | 37.5 | 2 | 5 | | 1 | 1 |
| 3 | 2 | 5 | 4 | 8 | 1 | 2 |

Rule 3 of Stage 1 is a catch-all rule that is intended to reserve all remaining resources from the table of resources, which are the resources described in records 3 and 5, for allocation into the allocated resources table. No changes are made to the allocation reservation table in this example. Thus, the working allocation table will appear as follows after processing of Stage 1, Rule 3:

| COST_ID | AMOUNT | DEPT_ID | ASSET_ID | LOC_ID | STAGE_ID | RULE_ID |
|---|---|---|---|---|---|---|
| 1 | 25 | 2 | 5 | | 1 | 1 |
| 2 | 37.5 | 2 | 5 | | 1 | 1 |
| 3 | 2 | 5 | 4 | 8 | 1 | 2 |
| 4 | 4 | 2 | | 8 | 1 | 3 |
| 5 | 75 | 5 | 4 | 8 | 1 | 3 |

In stage 2 and all subsequent stages, resources are no longer reserved from the table of resources. Rather, records may be reserved from the working allocation table (e.g., 30 in FIG. 1) and reallocated back into the working allocation table. Rule 1 of Stage 2 seeks all records where the LOC_ID is null, which in this example captures the records of the working allocation table having COST_ID equal to 1 and 2. Rule 1 next dictates that 50% of the reserved resources (25 and 37.5, respectively) should be reallocated to the location having LOC_ID=88, and the other 50% is to be reallocated to a location having a LOC_ID=99. After processing of Stage 2, rule 1 is complete, the allocation reservation table will look like this:

| ID | COST_ID | STAGE ID | RULE_ID |
|---|---|---|---|
| 1 | 1 | 1 | 1 |
| 2 | 2 | 1 | 1 |
| 3 | 4 | 1 | 2 |
| 4 | 1 | 2 | 1 |
| 5 | 2 | 2 | 1 |

The allocated resources table would look like this:

| COST_ID | AMOUNT | DEPT_ID | ASSET_ID | LOC_ID | STAGE_ID | RULE_ID |
|---|---|---|---|---|---|---|
| 1 | 25 | 2 | 5 | | 1 | 1 |
| 2 | 37.5 | 2 | 5 | | 1 | 1 |
| 3 | 2 | 5 | 4 | 8 | 1 | 2 |
| 4 | 4 | 2 | | 8 | 1 | 3 |
| 5 | 75 | 5 | 4 | 8 | 1 | 3 |
| 6 | 12.5 | 2 | 5 | 88 | 2 | 1 |
| 7 | 12.5 | 2 | 5 | 99 | 2 | 1 |
| 8 | 18.75 | 2 | 5 | 88 | 2 | 1 |
| 9 | 18.75 | 2 | 5 | 99 | 2 | 1 |

Rule 2 of stage 2 is another catch-all rule that reallocates into the working allocation table all records in the working allocation table that were not reallocated during stage 2. The resulting working allocation table will look like this:

| COST_ID | AMOUNT | DEPT_ID | ASSET_ID | LOC_ID | STAGE_ID | RULE_ID |
|---|---|---|---|---|---|---|
| 1 | 25 | 2 | 5 | | 1 | 1 |
| 2 | 37.5 | 2 | 5 | | 1 | 1 |
| 3 | 2 | 5 | 4 | 8 | 1 | 2 |
| 4 | 4 | 2 | | 8 | 1 | 3 |
| 5 | 75 | 5 | 4 | 8 | 1 | 3 |
| 6 | 12.5 | 2 | 5 | 88 | 2 | 1 |
| 7 | 12.5 | 2 | 5 | 99 | 2 | 1 |
| 8 | 18.75 | 2 | 5 | 88 | 2 | 1 |
| 9 | 18.75 | 2 | 5 | 99 | 2 | 1 |
| 10 | 2 | 5 | 4 | 8 | 2 | 2 |
| 11 | 4 | 2 | | 8 | 2 | 2 |
| 12 | 75 | 5 | 4 | 8 | 2 | 2 |

As demonstrated by this example, each stage may operate on records of the working allocation table that were created during the previous stage. To track stages, the stage during which a record of the working allocation table was created may be stored in the record.

Once data has been allocated (and reallocated, if there are multiple stages in a scenario) into a working allocation table, data from the working allocation table may be written back into the data warehouse. The final results of a scenario may be the records in the working allocation table that have the final stage number of the scenario. In the example above, all the records of the working allocation table having a STAGE_ID of 2 (i.e., the final stage of the example scenario) may be written back to the data warehouse as a revised table of resources (e.g., 38 in FIG. 1). Analytics and reporting may be performed using these revised resources.

As noted above, the allocation engine may be responsive to the allocation application interface. Changes to a scenario, including changes to its stages or rules, may immediately prompt the allocation engine to process the scenario. The following are examples of events at the allocation application interface that may prompt the allocation engine to process a scenario:
Creating a new rule;
Changing an existing rule;
Changing the sequence of rules within a stage;
Changing the sequence of stages in a scenario;
Inserting a new stage before an existing stage;
Deleting a scenario;
Deleting a stage;
Deleting a rule; and
Changing a scenario's start/end dates.

FIGS. 3-6 depict various exemplary GUIs 42 of an allocation application interface that may be used to configure scenarios, stages and rules. Although particular types of inputs (e.g., check boxes, drop-down menus) are shown in these examples, it should be understood that these examples are not meant to be limiting, and various types of inputs may be used in various locations to accomplish various goals.

The GUI 42 of FIG. 3 may be used to configure a scenario. A progress indicator 43 may be provided to indicate the processing status of the scenario, as well as the time the scenario was started and the duration of time required to process the scenario. Processing on this scenario is complete, which means the allocation engine is not currently working. However, when the allocation is working on scenario, the progress indicator 43 may indicate the percentage complete, as well as the start time and duration.

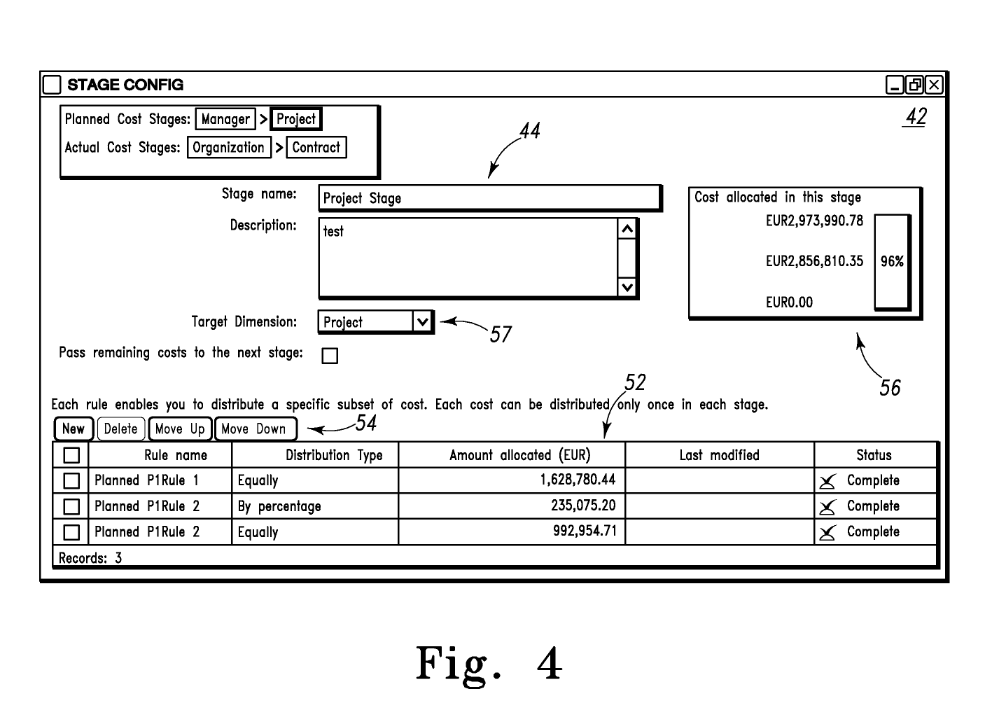

A scenario may be given a name and a description using name and description inputs 44. Date inputs 46 are also included for providing start and end dates that may be used to limit the scope of data processing in this scenario. A series of stages 48 called “Planned Cost Stages” is shown at the bottom and includes two stages: “Manager Stage” and “Project Stage.” A user may select stage name to pull up a GUI such as the one shown in FIG. 4 to edit the stage. A user also may be able to reorder stages using sequence inputs 50.

A publishing status box 51 also may be provided. It may indicate whether the results of the scenario as processed by the allocation engine have been published back to the data warehouse (e.g., by downstream ETL component 36). Publishing may be asynchronous relative to the GUI 42, and publishing status box 51 may display values such as “Unpublished,” Publication Requested,” “Publish in Progress” and “Publish Complete.”

FIG. 4 depicts an example GUI 42 for configuring a stage. As was the case with the GUI 42 for configuring scenarios of FIG. 3, a stage may be given a name and a description using name and description inputs 44. Stage-configuration GUI 42 also includes a series of rules 52 and rule sequence inputs 54 that may be used to edit and reorder rules within a stage, respectively.

Each rule in the series of rules 52 may include an “Amount Allocated” column that indicates to a user the amount of resources that are allocated according to the source criteria of that particular rule. Each rule in the series of rules 52 also may include a “Status” column, which may indicate to the user the progress of the series of rules 52. For example, a rule may have a status of “Draft,” “Reserving,” “Allocating,” and “Complete.”

Reserving resources (e.g., steps 102 and 108 of FIG. 2) may only require a moderate amount of computing resources. In contrast, allocating and reallocating reserved data (e.g., steps 104 and 108 of FIG. 2) may be resource-intensive. Accordingly, reserving and allocating may be executed separately and asynchronously. Thus, a user may be able to view the resources that are going to be reserved for allocation without having to wait for the actual allocation to be completed, which may occur some time later. To this end, an allocation indicator 56 may be provided that displays a sum of resources that are reserved during the present stage, prior to allocating the reserved resources into the working allocation table or back into the data warehouse.

In some embodiments, rules may be limited globally within a stage to reserve records of resources that are related to a particular dimension. For example, in FIG. 4, the GUI 42 includes a drop-down menu 57 labeled “Target dimension.” Drop-down menu 57 is used here to limit processing by the allocation engine of rules in this stage to records of resources having a “Project” dimension. Other stages of the same scenario may be directed to other dimensions. Accordingly, a user may cross reference resources between disparate data sources by chaining together a sequence of stages, each directed to a different dimension.

The stage configuration GUI 42 of FIG. 4 also includes an input labeled “Pass remaining costs to the next stage.” This input may be used to insert a catch-all rule such as the ones described in the application example above into the series of rules 52, typically in the last position.

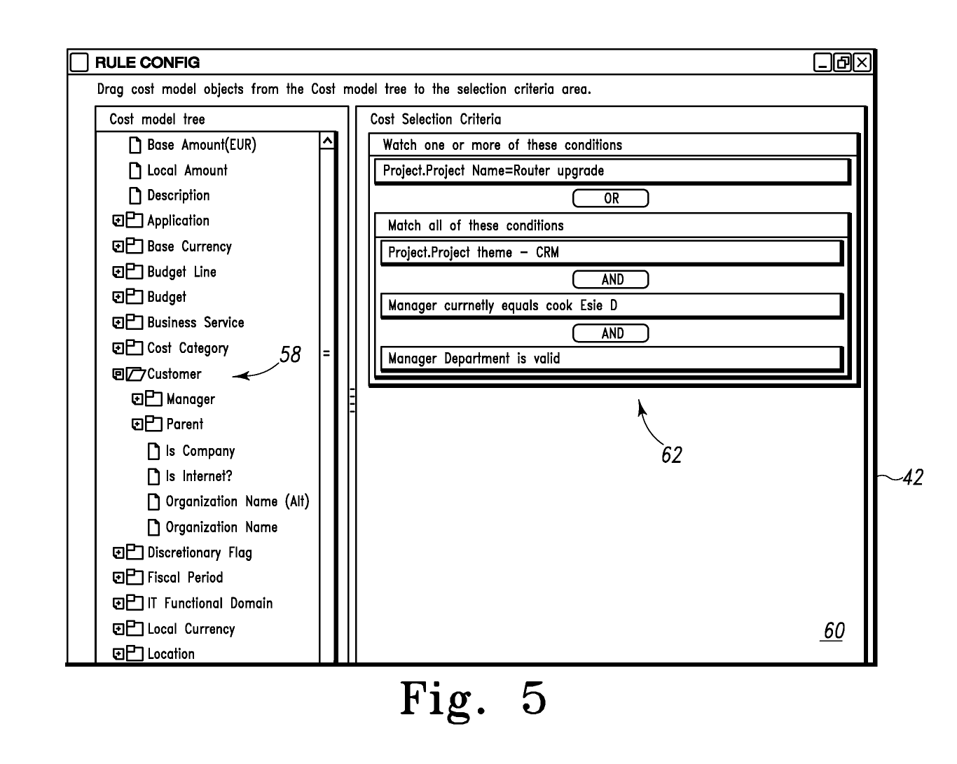

FIG. 5 depicts a GUI 42 that may be used to configure a rule. GUI 42 may include data dimension sources 58 that may be dragged and dropped onto a design area 60 in order to create and manipulate graphical representations 62 of rules. These graphical representations 62 may be usable to define source criteria that determine which records have resources that are to be reserved.

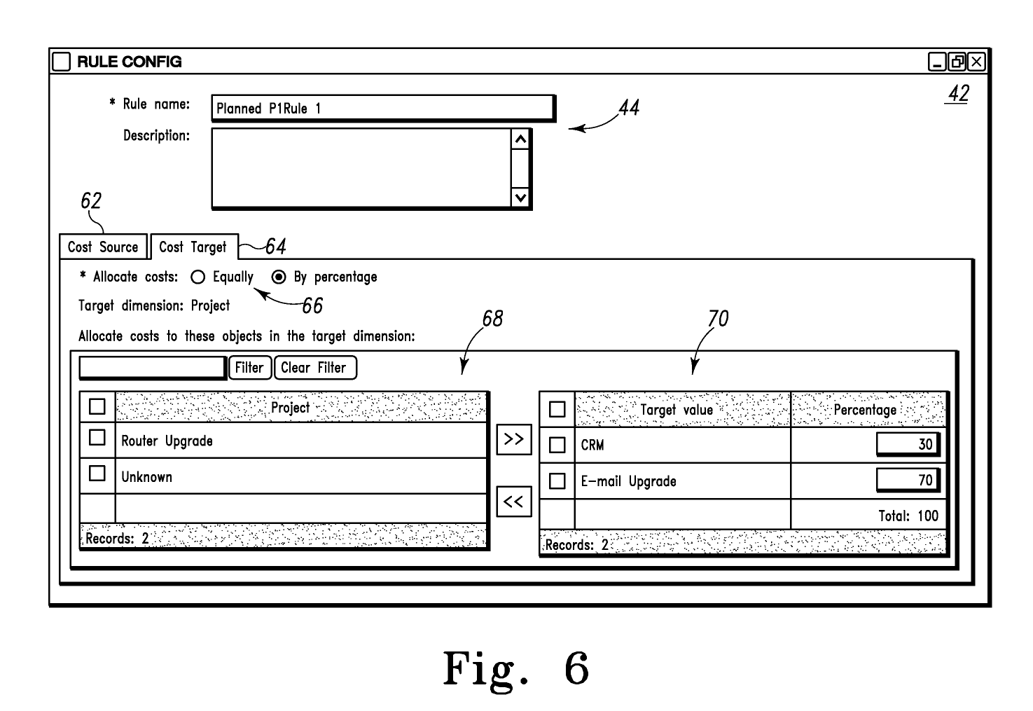

FIG. 6 depicts another GUI 42 that may be used to configure rules, and is more specifically tailored to configure source and target criteria of a rule that dictate from where resources are reserved and to where resources are allocated. Again, name and description inputs 44 are provided. A cost source edit area 62 and a cost target edit area 64 are provided to edit the source and target criteria, respectively, of a particular rule. The cost target edit area 64 is active here and includes inputs 66 for choosing a method of allocation of resources among multiple targets. In this example, the choices are “Equally” and “By percentage,” but other possibilities are contemplated herein.

Potential targets 68 may be provided that may be specific to a particular target dimension. In this example, each potential target is related to the “project” dimension. Selected targets 70 may be chosen from these potential targets 68 to dictate where resources are to be allocated. For each selected target 70, an amount of the resource that is to be allocated to the selected target may be defined (assuming the resource is not being allocated equally).

The disclosure set forth above may encompass multiple distinct embodiments with independent utility. The specific embodiments disclosed and illustrated herein are not to be considered in a limiting sense, because numerous variations are possible. The subject matter of this disclosure includes all novel and nonobvious combinations and subcombinations of the various elements, features, functions, and/or properties disclosed herein. The following claims particularly point out certain combinations and subcombinations regarded as novel and nonobvious. Other combinations and subcombinations of features, functions, elements, and/or properties may be claimed in applications claiming priority from this or a related application. Such claims, whether directed to a different embodiment or to the same embodiment, and whether broader, narrower, equal, or different in scope to the original claims, also are regarded as included within the subject matter of the present disclosure.

Where the claims recite “a” or “a first” element or the equivalent thereof, such claims include one or more such elements, neither requiring nor excluding two or more such elements. Further, ordinal indicators, such as first, second or third, for identified elements are used to distinguish between the elements, and do not indicate a required or limited number of such elements, and do not indicate a particular position or order of such elements unless otherwise specifically stated.

We claim:

1. A method of allocating resources in a data warehouse, comprising:
retrieving from the data warehouse a table of resources, the table including a plurality of records, each record having data that describes a resource to be allocated;
reserving a first resource described in a first record of the table of resources pursuant to a first rule of a first stage; and
allocating the first resource into one or more records of a working allocation table pursuant to the first rule.

2. The method of claim 1, further comprising:
reserving a second resource described in a second record of the table of resources pursuant to the first rule;
allocating the second resource into one or more records of the working allocation table pursuant to the first rule.

3. The method of claim 1, further comprising storing an identifier associated with the first record in an allocation reservation table to indicate that the first resource has been allocated.

4. The method of claim 1, further comprising reallocating a resource described in a record of the working allocation table pursuant to a rule of a second stage.

5. The method of claim 1, further comprising reallocating a resource described in a record of the working allocation table into one or more new records of the working allocation table pursuant to a rule of a second stage.

6. The method of claim 1, further comprising writing data from the working allocation table back into the data warehouse.

7. The method of claim 6, wherein writing data from the working allocation table back into the data warehouse further includes writing data from records of the working allocation table that were created in a final stage of a series of stages that includes the first stage.

8. The method of claim 6, wherein writing data from the working allocation table back into the data warehouse further includes providing data from the working allocation table to an extract, transform and load process.

9. The method of claim 2, further comprising outputting a sum of the first resource and the second resource prior to allocating the first or second resource into one or more records of the working allocation table.

10. The method of claim 1, further comprising outputting progress of allocating the first resource into one or more records of the working allocation table.

11. A computer-readable storage medium having computer-executable instructions for allocating resources in a data warehouse, the instructions causing a computer to perform steps comprising:
retrieving from the data warehouse a table of resources, the table including a plurality of records, each record having data that describes a resource to be allocated;
reserving a first resource described in a first record of the table of resources pursuant to a first rule of a first stage; and
allocating the first resource into one or more records of a working allocation table pursuant to the first rule.

12. The computer-readable storage medium of claim 11, further including computer-executable instructions for:
reserving a second resource described in a second record of the table of resources pursuant to the first rule;
allocating the second resource into one or more records of the working allocation table pursuant to the first rule.

13. The computer-readable storage medium of claim 11, further including computer-executable instructions for storing an identifier associated with the first record in an allocation reservation table to indicate that the first resource has been allocated.

14. The computer-readable storage medium of claim 11, further including computer-executable instructions for reallocating a resource described in a record of the working allocation table pursuant to a rule of a second stage.

15. The computer-readable storage medium of claim 11, further including computer-executable instructions for reallocating a resource described in a record of the working allocation table into one or more new records of the working allocation table pursuant to a rule of a second stage.

16. The computer-readable storage medium of claim 11, further including computer-executable instructions for writing data from the working allocation table back into the data warehouse.

17. The computer-readable storage medium of claim 16, wherein writing data from the working allocation table back into the data warehouse further includes writing data from records of the working allocation table that were created in a final stage of a series of stages that includes the first stage.

18. The computer-readable storage medium of claim 12, further including computer-executable instructions for outputting a sum of the first resource and the second resource prior to allocating the first or second resource into one or more records of the working allocation table.

19. The computer-readable storage medium of claim 11, further including computer-executable instructions for outputting progress of allocating the first resource into one or more records of the working allocation table.

20. A system for allocating resources, comprising:
a source database;
a data warehouse configured to retrieve a table of resources from the source database, the table including a plurality of records, each record having data that describes a resource to be allocated;
an allocation engine configured to:
reserve a first resource described in a first record of the table of resources pursuant to a rule of a first stage;
allocate the first resource into one or more records of a working allocation table pursuant to the rule;
store an identifier associated with the first record in an allocation reservation table to indicate that the first resource has been allocated; and
reallocate a resource described in a record of the working allocation table pursuant to a rule of a second stage.
